(19) United States
(12) Patent Application Publication
(10) Pub. No.: US 2025/0064664 A1
(43) Pub. Date: Feb. 27, 2025

(54) SPINE PIANO

(71) Applicant: Adal Bermann, San Diego, CA (US)

(72) Inventor: Adal Bermann, San Diego, CA (US)

(21) Appl. No.: 18/942,290

(22) Filed: Nov. 8, 2024

Related U.S. Application Data
(63) Continuation of application No. PCT/US2023/022000, filed on May 12, 2023.
Application No. PCT/US2023/022000 is a continuation-in-part of application No. 17/744,039, filed on May 13, 2022.

(51) Int. Cl. A61H 1/02; A61H 9/00

(52) U.S. Cl. CPC A61H 1/0292; A61H 9/0078; A61H 2201/0103; A61H 2201/1246; A61H 2201/1409

(57) ABSTRACT

Provided herein are devices for spine adjustment, comprising: a support structure configured to support a person, comprising: a first portion configured to support a top portion of the person, wherein the first portion comprises a plurality of movable columns; and a second portion configured to support a bottom portion of the person; and a solid frame configured to provide structure to the device, wherein the solid frame is physically coupled to the support structure.

### CROSS REFERENCE

This application is a Continuation of International Application No. PCT/US2023/022000 filed May 12, 2023, which is a continuation-in-part of U.S. application Ser. No. 17/744,039 filed May 13, 2022, each of which is incorporated herein by reference in its entirety.

### BACKGROUND

Proper alignment of the spine is critical to the health of the skeletal system and the spinal cord, the information superhighway of the central nervous system. Unfortunately, many people, such as those having desk-jobs, often have improper posture. For example, people with desk jobs may sit for a prolonged period of time without proper work ergonomics, which, overtime, may lead to improper spine alignment. Although stretching can be an effective way to alleviate some of the symptoms of improper spine alignment, stretching itself can be less effective when performed alone without support and assistance.

### SUMMARY

Aspects disclosed herein provide devices for spine adjustment, the devices comprising: (a) a support structure configured to support a person, comprising: (i) a first portion configured to support a top portion of the person, wherein the first portion comprises a plurality of movable columns; and (ii) a second portion configured to support a bottom portion of the person; and (b) a solid frame configured to provide structure to the device, wherein the solid frame is physically coupled to the support structure. In some embodiments, each movable column in the plurality of movable columns comprises: (a) a cushion configured to contact the person; (b) a vertical body physically coupled to the cushion; (c) a track physically coupled to the solid frame; and (d) a wheel physically coupled to the vertical body. In some embodiments, the cushion comprises rubber, foam, cork, wood, upholstered pillow material, or any combination thereof. In some embodiments, the cushion comprises one or more shapes. In some embodiments, the one or more shapes are configured to massage and support the top portion of the person. In some embodiments, the one or more shapes are designed to massage one or more muscles of the person. In some embodiments, the one or more shapes are designed to substantially limit direct contact with the spine of the person. In some embodiments, the vertical body is physically coupled to the track. In some embodiments, the track comprises a hollow passage, wherein a width of the hollow passage of the track is greater than a width of the vertical body. In some embodiments, the vertical body is configured to slide through the hollow passage of the track. In some embodiments, the solid frame comprises a plurality of wheels. In some embodiments, a template structure comprising a top configuration, wherein the template structure is configured to be inserted in a space between the plurality of wheels of the solid frame and each wheel of the moveable columns. In some embodiments, the top configuration is designed to contact the wheel of each of the movable columns. In some embodiments, the template structure is configured to slide across the plurality of wheels of the solid frame with respect to the solid frame. In some embodiments, the template structure further comprises a gear and a crank physically coupled to the template structure. In some embodiments, the gear and the crank are configured to move the template structure with respect to the solid frame. In some embodiments, the gear and the crank are moveable by human intervention, wherein when the human intervention moves the gear and the crank, the template structure moves as well. In some embodiments, the top configuration of the template structure is designed to move the movable columns vertically with respect to the solid frame when the template structure is moved. In some embodiments, the devices further comprise one or more silk wraps configured to move in a horizontal and/or a vertical direction with respect to the solid frame. In some embodiments, the one or more silk wraps are physically coupled to one or more cables. In some embodiments, the one or more cables are physically coupled to one or more pulleys and/or cranks. In some embodiments, the one or more pulleys and/or cranks are physically coupled to a support beam coupled to and positioned above the solid frame. In some embodiments, the support beam comprises one or more moveable tracks, wherein the one or more pulleys and/or cranks are positioned on the one or more moveable tracks and the one or more pulleys and/or cranks are configured to slide across the one or more moveable tracks. In some embodiments, the one or more silk wraps are configured to support, lift, and/or stretch a portion of the person, or any combination thereof. In some embodiments, the track comprises a first sliding plate and a second sliding plate for each moveable column in the plurality of moveable columns. In some embodiments, the first sliding plate and the second sliding plate are disposed atop the other. In some embodiments, the first sliding plate and the second sliding plate are held against the solid frame via horizontal bars. In some embodiments, the horizontal bars are configured to hold the first sliding plate and the second sliding plate with one or more clamps. In some embodiments, the one or more clamps are configured to add or reduce tension exerted on the on the first sliding plate and/or the second sliding plate by holding the horizontal bars to the solid frame. In some embodiments, the first sliding plate and the second sliding plate comprise holes comprising a width that is larger than a width of the vertical body. In some embodiments, the vertical body slides through the holes of the first sliding plate and the second sliding plate. In some embodiments, when the horizontal bars are released from the solid frame, the first sliding plate and the second sliding plate are movable in a horizontal plane, thereby changing the position and/or angle of one of the plurality of moveable columns.

Aspects disclosed herein provide devices for spine adjustment, the devices comprising: (a) a support structure configured to support a person, comprising: (i) a first portion configured to support a top portion of the person, wherein the first portion comprises a plurality of movable columns; and (ii) a second portion configured to support a bottom portion of the person; and (b) a solid frame physically coupled to the support structure. In some embodiments, each movable column in the plurality of movable columns comprises: (a) a cushion configured to contact the person; (b) a vertical body physically coupled to the cushion; and (c) a track physically coupled to the solid frame. In some embodiments, the devices further comprise a plurality of actuators, wherein each actuator in the plurality of actuators is physically coupled to each movable column of the plurality of movable columns. In some embodiments, the devices further comprise a control panel electrically coupled to the plurality of actuators. In some embodiments, the control panel is configured to move the plurality of actuators. In some embodiments, the control panel is electrically coupled to a processor. In some embodiments, the processor receives inputs from the control panel and sends the inputs as signals to the plurality of actuators to initiate movement of the plurality of movable columns with respect to the solid frame. In some embodiments, the control panel comprises a plurality of sliders, wherein each slider of the plurality of sliders corresponds to each actuator of the plurality of actuators. In some embodiments, the plurality of sliders are physical or digital. In some embodiments, the plurality of sliders are movable upwards or downwards by a user. In some embodiments, when the user moves one of the sliders of the plurality of sliders in the control panel in a first direction to a first position, the corresponding movable column is configured to move in the same first direction to the same corresponding first position. In some embodiments, the control panel comprises a plurality of switches. In some embodiments, the plurality of switches comprise two-way switches. In some embodiments, the two-way switches comprise toggles or joysticks. In some embodiments, when a switch of the plurality of switches is held in a first direction for a period of time, a corresponding actuator of the plurality of actuators moves in the same corresponding first direction for the same period of time. In some embodiments, the devices further comprise one or more silk wraps configured to move in a horizontal and/or a vertical direction with respect to the solid frame. In some embodiments, the one or more silk wraps are physically coupled to one or more cables. In some embodiments, the one or more cables are physically coupled to one or more pulleys and/or cranks. In some embodiments, the one or more pulleys and/or cranks are physically coupled to a support beam coupled to and positioned above the solid frame. In some embodiments, the support beam comprises one or more moveable tracks, wherein the one or more pulleys and/or cranks are positioned on the one or more moveable tracks and the one or more pulleys and/or cranks are configured to slide across the one or more moveable tracks. In some embodiments, the one or more silk wraps are configured to support, lift, and/or stretch a portion of the person, or any combination thereof. In some embodiments, the devices further comprise one or more silk wraps configured to move in a horizontal and/or a vertical direction with respect to the solid frame. In some embodiments, the one or more silk wraps are physically coupled to one or more cables. In some embodiments, the one or more cables are physically coupled to one or more pulleys and/or cranks. In some embodiments, the one or more pulleys and/or cranks are physically coupled to a support beam coupled to and positioned above the solid frame. In some embodiments, the support beam comprises one or more moveable tracks, wherein the one or more pulleys and/or cranks are positioned on the one or more moveable tracks and the one or more pulleys and/or cranks are configured to slide across the one or more moveable tracks. In some embodiments, the one or more silk wraps are configured to support, lift, and/or stretch a portion of the person, or any combination thereof. In some embodiments, the track comprises a first sliding plate and a second sliding plate for each moveable column in the plurality of moveable columns. In some embodiments, the first sliding plate and the second sliding plate comprise low-friction polymer, metal, wood, plastic, bearings to reduce friction, or any combination thereof. In some embodiments, the first sliding plate and the second sliding plate are disposed atop the other. In some embodiments, the first sliding plate and the second sliding plate are held against the solid frame via horizontal bars. In some embodiments, the horizontal bars are configured to hold the first sliding plate and the second sliding plate with one or more clamps. In some embodiments, the one or more clamps are configured to add or reduce tension exerted on the on the first sliding plate and/or the second sliding plate by holding the horizontal bars to the solid frame. In some embodiments, the first sliding plate and the second sliding plate comprise holes comprising a width that is larger than a width of the vertical body. In some embodiments, the vertical body slides through the holes of the first sliding plate and the second sliding plate.

Aspects disclosed herein provide devices for spine adjustment, the devices comprising: (a) a support structure configured to support a person, comprising one or more inflatable segments, wherein the one or more inflatable segments comprises one or more cushions and one or more chambers; (b) one or more valves connected to one or more chambers, wherein each of the one or more chambers is physically coupled to the one or more cushions; (c) an air compressor configured to provide air to the one or more inflatable segments; and (d) a solid frame physically coupled to the support structure. In some embodiments, the devices further comprise an air compressor tube. In some embodiments, the air compressor tube physically connects the air compressor to the one or more valves. In some embodiments, the air compressor is disposed adjacent to the support structure. In some embodiments, the one or more inflatable segments are hermetic. In some embodiments, the one or more inflatable segments comprises rubber, sealed canvas, or any other hermetic flexible material. In some embodiments, the one or more inflatable segments are configured to grow using air provided by the air compressor. In some embodiments, each cushion of the one or more inflatable segments is between 2 to 40 inches in length. In some embodiments, the one or more inflatable segments are configured to wrap around a portion of a person. In some embodiments, the one or more inflatable segments are configured to compress the legs of the person using air from the air compressor. In some embodiments, the one or more inflatable segments are configured to rise and fall with air in a sequence in order to provide a massage to the person.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A shows a side view of a non-limiting example of a device for spine adjustment as provided herein having actuators in a starting position;

FIG. 1B shows a side view of the device for spine adjustment in FIG. 1A in a working position to adjust the spine of a person;

FIG. 1C shows a non-limiting example of a control panel having analog sliders that can be used to control the device for spine adjustment in FIG. 1A;

FIG. 1D shows a non-limiting example of a control panel having digital sliders that can be used to control the device for spine adjustment in FIG. 1A;

FIG. 1E shows a non-liming example of moveable columns in the device for spine adjustment in FIG. 1A;

FIG. 2A shows a side view of a non-limiting example of a device for spine adjustment having inflatable segments, a compressor, chambers, and valves, in a starting position;

FIG. 2B shows a side view of the device for spine adjustment in FIG. 2A in a working position to adjust the spine of a person;

FIG. 3 shows cross-sectional views of non-limiting examples of cushions of the moveable columns with one or more shapes having different shapes that make contact with a person;

FIG. 4A shows a side view of a non-limiting example of a device for spine adjustment having moveable columns on a template structure in a working position to adjust the spine of a person;

FIG. 4B shows a non-liming example of moveable columns in the device for spine adjustment in FIG. 4A;

FIG. 5A shows a side view of a non-limiting example of a device for spine adjustment having electrical actuator switches in a working position to adjust the spine of a person;

FIG. 5B shows a non-limiting example of a joystick type control mechanism;

FIG. 5C shows a non-limiting example of a thumbwheel type control mechanism;

FIG. 6 shows a side view of a non-limiting example of a device for spine adjustment having inflatable segments configured to wrap around the legs of a person;

FIG. 7 shows a non-limiting example of a device for spine adjustment with silk wraps hanging above the device;

FIG. 8 shows a side view of a non-limiting example of a solid frame of the device for spine adjustment having moveable columns, sliding plates, and horizontal bars; and

FIG. 9 shows a side view of a non-limiting example of a solid frame of the device for spine adjustment having moveable columns, sliding plates, and horizontal bars.

### DETAILED DESCRIPTION

### Overview

Disclosed herein are devices, systems and methods in which the spine of a person

is adjusted to restore proper alignment, increase flexibility, create a supportive and pleasurable sensation during stretching of the spine of the person, or any combination thereof.

Provided herein are embodiments of devices for adjusting the spine of a person. In some embodiments, the device is controlled with a control panel that is electrically coupled to a plurality of actuators. In some embodiments, the device is controlled with a gear and a crank suitable for human interaction and where the crank is physically coupled to a template structure. In some embodiments, the device is controlled with an air compressor configured to provide air to inflatable segments comprising chambers and/or cushions of the device. In some embodiments, the device comprises a support structure configured to hold the weight of a person, comprising a first portion configured to support a top portion of the person, wherein the first portion comprises a plurality of movable columns, and a second portion configured to support a bottom portion of the person; and a solid frame physically coupled to the support structure. In some embodiments, the device for spine adjustment, comprises a support structure configured to support a person, comprising one or more inflatable segments, wherein the one or more inflatable segments comprises one or more cushions and one or more chambers; one or more valves connected to one or more chambers, wherein each of the one or more chambers is physically coupled to the one or more cushions; an air compressor configured to provide air to the one or more inflatable segments; and a solid frame physically coupled to the support structure. Further provided herein are methods for adjusting the spine of a person using the devices described herein.

### Example Devices for Spine Adjustment

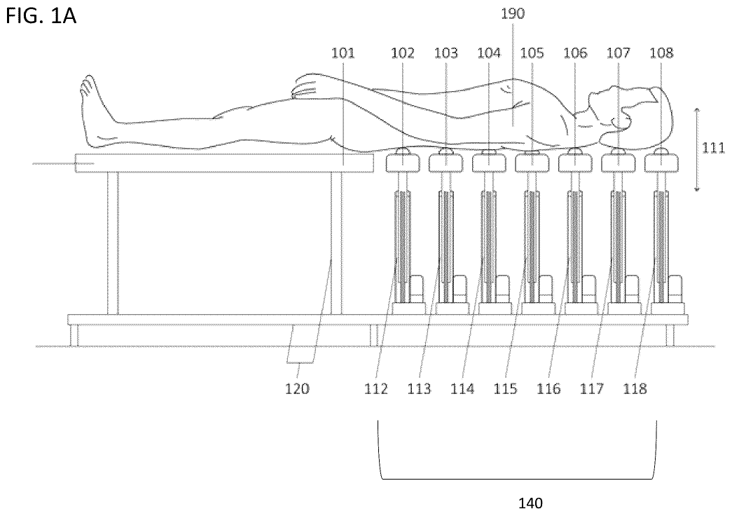

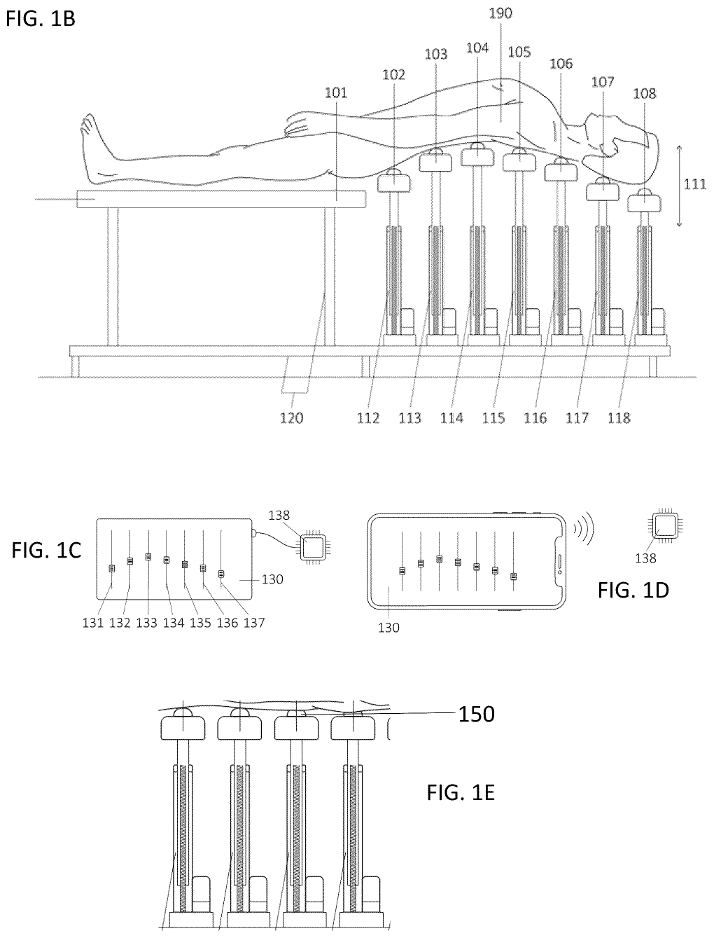

With reference to FIGS. 1A and 1B, an example of a device for spine adjustment (e.g., a “Spine Piano”) is depicted, according to some embodiments. FIG. 1A shows a side view of the relative position between the device and a person (190) laying on top of the device. In some embodiments, the device for spine adjustment comprises a support structure (101-108) configured to hold the weight of a person (190). In some embodiments, the support structure (101-108) comprises a first portion (102-108) and a second portion (101). In some embodiments, the first portion (102-108) of the support structure (101-108) is configured to support the weight of the person (190), for example the top portion of the person (190). The top portion of the person (190) may comprise the hips, lower back, upper back, shoulders, neck, head, or any combination thereof of the person (190). In some embodiments, the second portion (101) of the support structure (101-108) is configured to support the weight of the person (190), for example the bottom portion of the person (190). The bottom portion of the person (190) may comprise the hips, gluteus maximus region, legs, feet, or any combination thereof of the person (190).

In some embodiments, the support structure (101-108) is physically coupled to a stationary solid frame (120). In some embodiments, the solid frame (120) is fixed to the ground. In some embodiments, the sold frame (120) is bolted to the ground. In some embodiments, the solid frame (120) is configured to provide structure and support to the device. In some embodiments, the solid frame (120) comprises wheels. In some embodiments, the solid frame (120) is configured to hold and provide structure to the support structure (101-108) so that the support structure (101-108) can hold the weight of the person (190). In some embodiments, the solid frame (120) comprises metal, wood, plastic, or any combinations thereof.

In some embodiments, the first portion (102-108) of the support structure (101-108) may comprise a plurality of moveable columns (140). FIGS. 1A and 1B depict a non-limiting example of a device for spine adjustment comprising seven movable columns (140). In some embodiments, the device for spine adjustment may comprise a plurality of moveable columns (140). In some embodiments, the moveable columns are each configured to move up and down vertically (along directions shown by arrow 111) to change the curvature of the spine of a person. In some embodiments, the device for spine adjustment may comprise one or more, two or more, three or more, four or more, five or more, six or more, seven or more, eight or more, nine or more, ten or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, or 30 or more movable columns (140). In some embodiments, the device for spine adjustment may comprise 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, 3 or less, 2 or less, or 1 or less movable columns (140).

In some embodiments, the device for spine adjustment may comprise a plurality of actuators (112-118). In some embodiments, each moveable column in the plurality of movable columns (140) may be physically coupled to an actuator in the plurality of actuators (112-118). In some embodiments, each actuator physically coupled to each moveable column may be configured to move the moveable columns in a vertical direction with respect to the solid frame (120). In some embodiments, each actuator in the plurality of actuators (112-118) is a linear actuator. In some embodiments, each actuator in the plurality of actuators (112-118) may be hydraulic, pneumatic, electrical magnetic, or mechanical, or any combination thereof. In some embodiments, each actuator in the plurality of actuators (112-118) is a motion actuator.

FIGS. 1A and 1B depict a non-limiting example of a device for spine adjustment comprising seven linear actuators (112-118). In some embodiments, the device for spine adjustment may comprise one or more, two or more, three or more, four or more, five or more, six or more, seven or more, eight or more, nine or more, ten or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, or 30 or more linear or non-linear actuators in the plurality of actuators (112-118). In some embodiments, the device for spine adjustment may comprise 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, 3 or less, 2 or less, or 1 or less linear or non-linear actuators in the plurality of actuators (112-118).

With reference to FIG. 1B, the moveable columns of the plurality of moveable columns (140) may be positioned to push into the back of the person (190), creating a backward bending curvature in the spine of the person (e.g., the middle portion of the spine of the person is pushed upwards, while the lower back of the person and the neck of the person is lower than the middle portion of the spine of the person).

With reference to FIGS. 1C and 1D, the devices for spine adjustment described herein may comprise a control panel (130). In some embodiments, the control panel (130) may be electrically coupled to the plurality of actuators (112-118). In some embodiments, the control panel (130) comprises a control interface.

In some embodiments, the control panel (130) may comprise a plurality of sliders (131-137). In some embodiments, the plurality of sliders (131-137) of the control panel (130) may correspond to the plurality of actuators (112-118) of the device for spine adjustment. In some embodiments, the sliders of the plurality of sliders (131-137) of the control panel (130) may be configured to control the vertical movement of the moveable columns of the plurality of moveable columns (140). In some embodiments, the plurality of sliders (131-137) may be movable in a vertical direction with respect to the control panel (130). In some embodiments, the plurality of sliders (131-137) may be moveable by human touch. In some embodiments, when a user moves a slider of the plurality of sliders (131-137) in the control panel (130) in a first direction, the corresponding movable column of the plurality of moveable columns (140) is configured to move in the same first direction. For example, in some embodiments, a slider in the left-most position (e.g., 131) of the control panel (130) may correspond to an actuator (e.g., 112) connected to a movable column of the plurality of moveable columns (140) also in the left-most position of the device for spine adjustment. In this example, when the slider (131) is moved in a first direction (e.g., up with respect to the control panel (130)), the actuator (112) and the movable column of the plurality of moveable columns (140) connected to the actuator (112) is moved in the same first direction (e.g., upwards with respect to the device for spine adjustment). In some embodiments, the sliders of the plurality of sliders (131-137) of the control panel (130) model, at a smaller scale, the layout and range of the actuators of the plurality of actuators (112-118) of the device.

In some embodiments, the control panel (130) can be built in such a way that it can record memory of times and coordinates of the sliders of the plurality of sliders (131-137) (and corresponding actuators of the plurality of actuators (112-118)) over a period of time, and replay that sequence of motion and positions on demand. The control panel (130) may also be constructed so as to provides a method by which users may save, share and use different memorized sequences, starting positions and customizations to how the control panel (130) may interpret the positions of the sliders of the plurality of sliders (131-137) to determine the motion and target positions of the actuators of the plurality of actuators (112-118).

In some embodiments, each actuator in the plurality of actuators (112-118) may be controlled individually by the control panel (130) such that each actuator of the plurality of actuators (112-118) can move independent of other actuators in the plurality of actuators (112-118). In some embodiments, each actuator of the plurality of actuators (112-118) may be configured to move independent of the other actuators of the plurality of actuators (112-118), such that any or all of the other actuators of the plurality of actuators (112-118) can move up at the same time, move down at the same time, or move in opposite directions at the same time. In some embodiments, each actuator in the plurality of actuators (112-118) can move one after another in a sequential manner.

FIGS. 1C and 1D depict non-limiting examples of control panels (130). The control panels (130) depicted in FIGS. 1C and 1D comprise seven sliders (131-137) that correspond to seven actuators (112-118) depicted in FIGS. 1A and 1B. In some embodiments, the control panel (130) may comprise more than seven sliders or less than seven sliders. In some embodiments, the control panel (130) may comprise one or more, two or more, three or more, four or more, five or more, six or more, seven or more, eight or more, nine or more, ten or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, or 30 or more sliders. In some embodiments, the control panel (130) may comprise 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, 3 or less, 2 or less, or 1 or less sliders.

In some embodiments, and with reference to FIG. 1C, the control panel (130) may comprise physical sliders. In some embodiments, the control panel (130) may comprise analog sliders. FIG. 1C shows an analog version of the control panel (130) in which the plurality of sliders (131-137) can be moved mechanically, for example, by a person's hand. In some embodiments, and with reference to FIG. 1D, the control panel (130) may comprise digital sliders. In some embodiments, the sliders (131-137) of the control panel (130) may be moveable by human touch. In some embodiments, the sliders (131-137) of the control panel (130) may be moved automatically (e.g., without human touch). FIG. 1D shows a digital version of the control panel, such as an application (“app”) on a mobile device, in which representations of the sliders may be displayed on a tactile touch screen and can be adjusted with touch and motion (e.g., finger motion).

In some embodiments, and with reference to FIGS. 1C and 1D, the control panel (130) may be coupled to a processor (138). In some embodiments, and with reference to FIG. 1C, the control panel (130) may be physically coupled to the processor (138). In some embodiments, the control panel (130) physically coupled to the processor (138) may be coupled to the processor (138) through a wire. In some embodiments, and with reference to FIG. 1D, the control panel (130) may be electrically coupled to the processor (138). In some embodiments, the control panel (130) electrically coupled to the processor (138) may be electrically coupled through, for example, Bluetooth, a computer network, a local network, Wi-Fi, Wireless LAN, a mobile network, a personal network, or any combination thereof.

In some embodiments, the processor (138) may be configured to receive inputs from the control panel (130). For example, when one of the sliders in the plurality of sliders (131-137) of the control panel (130) is moved, the control panel (130) may send an input to the processor (138), thereby communicating the change in movement of the slider in the plurality of sliders (131-137). In some embodiments, the processor (138) is configured to send the inputs received from the control panel (130) to the corresponding actuator in the plurality of actuators (112-118) of the device for spine adjustment.

In some embodiments, the control panel (130) comprises a processor (138) that may interpret an input from the control panel (130) and sends signals to the plurality of actuators (112-118) to initiate movement of the moveable columns in the plurality of moveable columns (140). In some embodiments, when a slider in the plurality of sliders (131-137) is moved to a new position, the control panel (130) may activate the corresponding actuator in the plurality of actuators (112-118) so that the corresponding actuator in the plurality of actuators (112-118) moves the corresponding moveable column in the plurality of moveable columns (140) to a specific vertical coordinate that is calculated proportionally to the new position of that slider in the plurality of sliders (131-137).

In some embodiments, in cases where a control panel (130) is used, the person (190) may move the sliders (131-137) of the control panel (130) to different positions and thus experience massage and stretching from the movement of the plurality of moveable columns (140) that will move to the position defined by the control panel (130). In some embodiments, the person (190) may move all or some of the sliders (131-137) of the control panel (130) in a first direction and thus experience massage and stretching from the movement of the plurality of moveable columns (140) moving in that same first direction. In some embodiments, a user that is not the person (190) may move the sliders (131-137) of the control panel (130) to different positions and thus, the person (190) may experience massage and stretching from the movement of the plurality of moveable columns (140) that will move to the position defined by the control panel (130).

In some embodiments, and with reference to FIG. 1E, each moveable column of the plurality of movable columns (140) may comprise a cushion (150) configured to contact a person. In some embodiments, the cushion (150) is positioned disposed over the top of each movable column of the plurality of movable columns (140). In some embodiments, the cushion (150) comprises rubber, foam, cork, wood, upholstered pillow material, or any combination thereof.

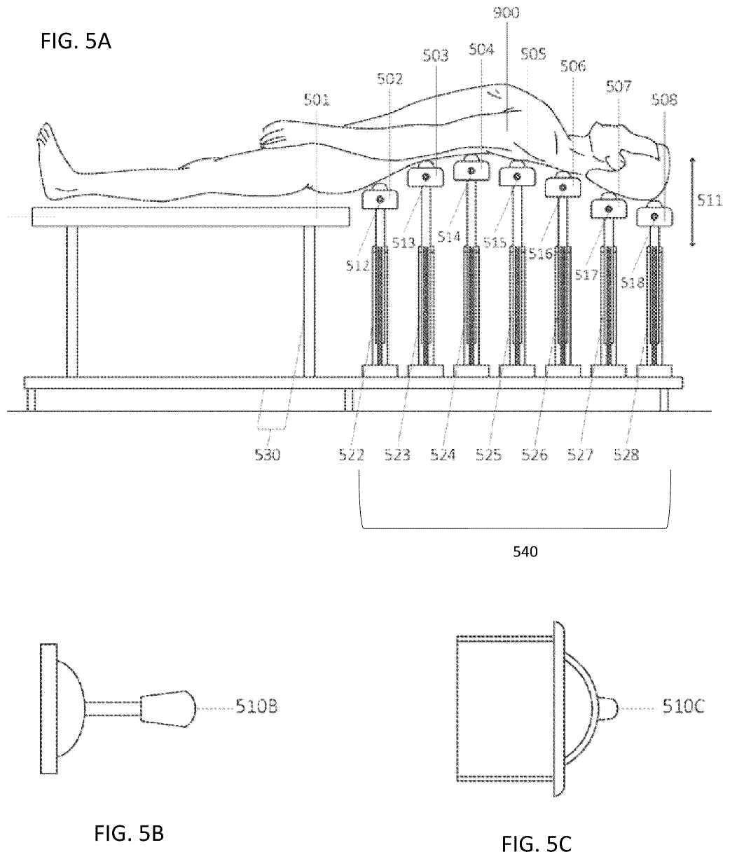

FIG. 5A shows another example of a device for spine adjustment (e.g., a “Spine Piano”) having a control panel comprising a plurality of switches (512-518) each connected to their respective actuators (522-528). In some embodiments, the plurality of switches (512-518) may be electrical “actuator switches” such as a joystick (510B) or a thumbwheel (510C) (FIG. 5B or FIG. 5C), or other similar electrical switches that can be used to control the flow of electrical power to the actuators (522-528) that control the movement of moveable columns of the plurality of moveable columns (540).

FIG. 5A comprises a plurality of moveable columns (540) that may be the same as or substantially similar to the plurality of movable columns in FIG. 1 (140). In some embodiments, the switches in the plurality of switches (512-518) may be two-way switches. In some embodiments, the two-way switches may comprise toggles (510C) or joysticks (510B). In some embodiments, each switch in the plurality of switches (512-518) is connected to its corresponding actuator in the plurality of actuators (522-528) through a wire. In some embodiments, when a switch of the plurality of switches (512-518) is moved or held in a first direction for a period of time, a corresponding actuator in the plurality of actuators (522-528) (and a movable column in the plurality of moveable columns (540) connected to the corresponding actuator in the plurality of actuators (522-528)) is moved in the same direction for the same period of time (e.g., until the actuator reaches the end of its track or the switch is no longer pressed/moved). For example, if a user pushes one or more switches (512-518) up or down, the corresponding actuators in the plurality of actuators (522-528) (and the movable column in the plurality of moveable columns (540) connected to the corresponding actuator in the plurality of actuators (522-528)) may move in that same direction (up or down) until the user releases pressure on the switch, or until the moving part of the actuators in the plurality of actuators (522-528) reaches the end of its range of motion. In some embodiments, to use the devices described herein, a person (590) may lie on the device, facing up with the upper portion of the body of the person (590) resting on the first portion (502-508) of the support structure (501-508) and the lower portion of the body of the person (590) resting on a second portion (501) of the support structure (501-508).

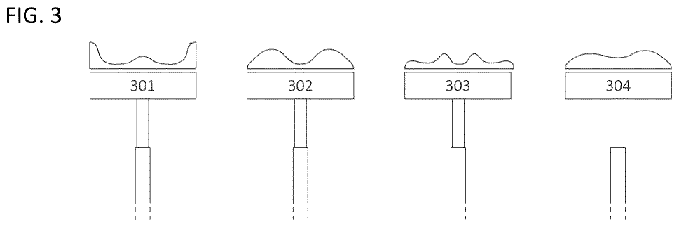

In some embodiments, and now referring to FIG. 3, the cushion (150) positioned atop each moveable column in the plurality of movable columns (140) may comprise a shape comprising one or more shapes. For example, the shape of the cushion (150) may be designed with one or more shapes such as one or more of the non-limiting examples depicted in FIG. 3 (e.g., 301, 302, 303, 304). In some embodiments, the shape of the one or more shapes comprises one or more of a form, a geometry, a groove, or a combination thereof. In some embodiments, the shape of the one or more shapes of the cushion (150) may be configured to massage the person (190). In some embodiments, the shape of the one or more shapes of the cushion (150) may be configured to contact the muscles of the person (190). In some embodiments, the shape of the one or more shapes of the cushion (150) may be configured or designed to substantially limit direct contact with the spine of the person (190). In some embodiments, the shape of the one or more shapes of the cushion (150) may be configured to avoid contact with the spine of the person (190) and make contact with the muscles of the person (190). For example, the designs (e.g., 301, 302, 303, 304) shown in FIG. 3 may be configured to avoid the spine of the person (190) and contact the muscles of the person (190).

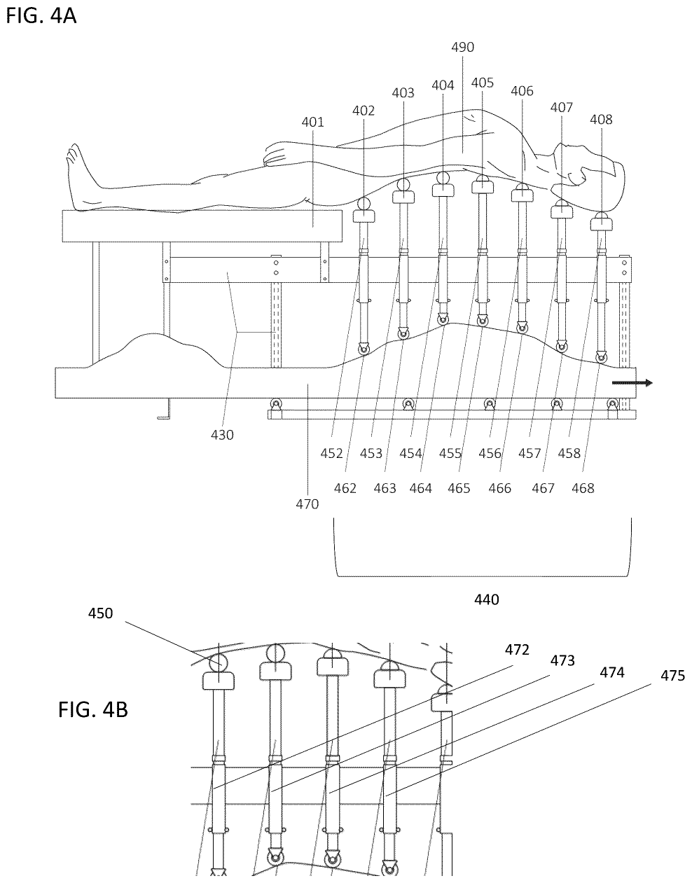

With reference to FIG. 4A, an example of a device for spine adjustment is depicted, according to some embodiments. In some embodiments, the device for spine adjustment comprises a support structure (401-408) configured to hold the weight of a person (490). FIG. 4A comprises a support structure (401-408) that may be the same as or substantially similar to the support structure in FIG. 1 (101-108). In some embodiments, the support structure (401-408) comprises a first portion (402-408) and a second portion (401). In some embodiments, the first portion (402-408) of the support structure (401-408) is configured to support the weight of the person (490), for example the top portion of the person (490). The top portion of the person (490) may comprise the hips, lower back, upper back, shoulders, neck, head, or any combination thereof of the person (490). In some embodiments, the second portion (401) of the support structure (401-408) is configured to support the weight of the person (490), for example the bottom portion of the person (490). The bottom portion of the person may comprise the hips, gluteus maximus region, legs, feet, or any combination thereof of the person (490).

In some embodiments, the support structure (401-408) is physically coupled to a stationary solid frame (430). FIG. 4A comprises a solid frame (430) that may be the same as or substantially similar to the solid frame in FIG. 1 (120). In some embodiments, the solid frame (430) is fixed to the ground. In some embodiments, the sold frame (430) is bolted to the ground. In some embodiments, the sold frame (430) comprises wheels. In some embodiments, the solid frame (430) is configured to provide structure and support to the device for spine adjustment. In some embodiments, the solid frame (430) is configured to hold and provide structure to the support structure (401-408) so that the support structure (401-408) can hold the weight of the person (490). In some embodiments, the solid frame (430) comprises metal, wood, plastic, or any combinations thereof. In some embodiments, the solid frame (430) may comprise a plurality of wheels.

In some embodiments, the first portion (402-408) of the support structure (401-408) may comprise a plurality of moveable columns (440). FIG. 4A comprises a plurality of moveable columns that may be the same as or substantially similar to the plurality of movable columns in FIG. 1A (140). FIG. 4A depicts a non-limiting example of a device for spine adjustment comprising seven movable columns (440). In some embodiments, the device for spine adjustment may comprise a plurality of moveable columns (440). In some embodiments, the device for spine adjustment may comprise one or more, two or more, three or more, four or more, five or more, six or more, seven or more, eight or more, nine or more, ten or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, or 30 or more movable columns (440). In some embodiments, the device for spine adjustment may comprise 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, 3 or less, 2 or less, or 1 or less movable columns (440).

FIG. 4B comprises elements of each moveable column of the plurality of moveable columns (440), in some embodiments. In some embodiments, each moveable column of the plurality of moveable columns (440) may comprise a cushion (450), a vertical body (452-458), a track (472-478), and a wheel (462-468), or any combination thereof.

In some embodiments, each moveable column of the plurality of movable columns (440) may comprise a cushion (450) configured to contact a person (490). FIG. 4B comprises a cushion (450) that may be the same as or substantially similar to the cushion FIG. 1A (150). In some embodiments, the cushion (450) is disposed over the top of each movable column of the plurality of movable columns (440). In some embodiments, the cushion (450) is configured to contact the (490) person on the device for spine adjustment when the person (490) is present on the device. In some embodiments, the cushion (450) comprises rubber, foam, a plurality of cells, cork, wood, upholstered pillow material, or any combination thereof.

In some embodiments, and now referring to FIG. 3, the cushion (450) disposed over the top of each moveable column in the plurality of movable columns (440) may comprise a shape comprising one or more shapes. For example, the shape of the cushion (450) may be designed with one or more shapes such as one or more of the non-limiting examples depicted in FIG. 3 (e.g., 301, 302, 303, 304). In some embodiments, the shape of the one or more shapes of the cushion (450) may be configured to massage the person (490). In some embodiments, the shape of the one or more shapes of the cushion (450) may be configured to contact the muscles of the person (490). In some embodiments, the shape of the one or more shapes of the cushion (450) may be designed to avoid contact with the spine of the person (490). In some embodiments, the shape of the one or more shapes of the cushion (450) may be designed to avoid contact with the spine of the person (490) and contact the muscles of the person (490). For example, the designs (e.g., 301, 302, 303, 304) shown in FIG. 3 may be configured to avoid the spine of the person (490) and contact the muscles of the person (490).

FIG. 4B shows a non-limiting example of the plurality of moveable columns in the device for spine adjustment in FIG. 4A. In some embodiments, each moveable column of the plurality of movable columns (440) may comprise a vertical body (452-458). In some embodiments, the vertical body (452-458) may be physically coupled to the cushion (450). In some embodiments, the vertical body (452-458) may be physically coupled to a wheel (462-468). In some embodiments, the vertical body (452-458) comprises metal. In some embodiments, the vertical body (452-458) comprises a width greater than a width of a hollow passage of the track (472-475). The hollow passage of the track may be a circular or non-circular opening in the track (472-475). In some embodiments, the vertical body (452-458) comprises a width less than a width of a hollow passage of the track (472-475). In some embodiments, the vertical body (452-458) slides through the track (472-475).

In some embodiments, each moveable column of the plurality of movable columns (440) may comprise the track (472-475). In some embodiments, the track (472-475) may be physically coupled to the stationary solid frame (430). In some embodiments, the track (472-475) is bolted to the solid frame (430). In some embodiments, the track (472-475) comprises metal. In some embodiments, the track (472-475) is physically coupled to the vertical body (452-458). In some embodiments, the track (472-475) comprises a hollow passage. In some embodiments, the hollow passage of the track (472-475) comprises a width greater than a width of the vertical body (452-458). In some embodiments, the hollow passage of the track (472-475) is circular or non-circular. In some embodiments, the hollow passage of the track (472-475) comprises a width less than the width of the vertical body (452-458).

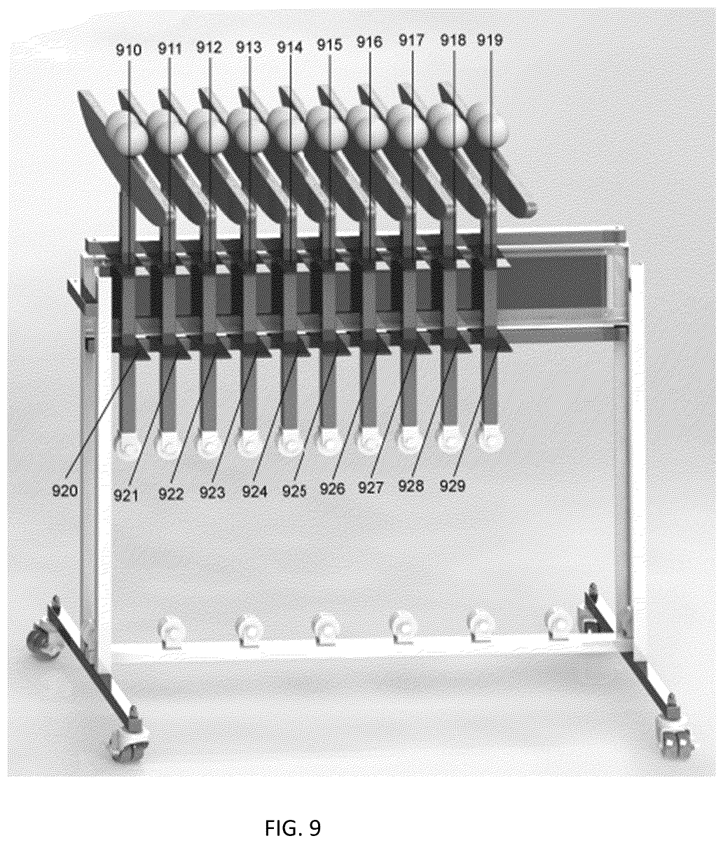

In some embodiments, and with reference to FIGS. 8 and 9, the track (472-475) of the plurality of moveable columns (440) may comprise a first sliding plate (910-919) and a second sliding plate (920-929). In some embodiments, the first sliding plate (910-919) and the second sliding plate (920-929) may comprise a low-friction polymer, such as, for example, delrin, acetal, or polyoxymethylene (POM). In some embodiments, the first sliding plate (910-919) and the second sliding plate (920-929) may comprise metal, wood, plastic, or any combination thereof. In some embodiments, the first sliding plate (910-919) and the second sliding plate (920-929) may comprise one or more bearings to reduce friction. In some embodiments, the first sliding plate (910-919) and the second sliding plate (920-929) are disposed atop the other. In some embodiments, the first sliding plate (910-919) and the second sliding plate (920-929) are held and/or positioned against the solid frame (430) via horizontal bars (811-812).

In some embodiments, the horizontal bars (811-812) are configured to hold the first sliding plate (910-919) and the second sliding plate (920-929) with one or more clamps. In some embodiments, the one or more clamps are configured to add or reduce tension exerted on the first sliding plate (910-919) and/or the second sliding plate (920-929) by holding the horizontal bars (811-812) to the solid frame (430). In some embodiments, the first sliding plate (910-919) and the second sliding plate (920-929) comprise a hollow passage that has a width that is larger than a width of the vertical body. In some embodiments, the vertical body slides through the hollow passage of the first sliding plate (910-919) and the second sliding plate (920-929). In some embodiments, the hollow passage is circular or non-circular. In some embodiments, when the horizontal bars (811-812) are released from the solid frame (430), the sliding plates (e.g., 910-919, 920-929) are movable in a horizontal plane with respect to the solid frame (430). In some embodiments, when the horizontal bars (811-812) are released from the solid frame (430), the sliding plates (e.g., 910-919, 920-929) are configured to move in any direction in a horizontal plane with respect to the solid frame (430), thereby changing the position and/or angle of the moveable columns of the plurality of movable columns (440). In some embodiments, where the position and/or angle of the moveable columns of the plurality of moveable columns (440) are changed, a massage is provided to the person on the device.

In some embodiments, and now referring to FIG. 4A, the plurality of movable columns (440) may comprise wheels (462-468). In some embodiments, the wheels (462-468) are physically coupled to the plurality of vertical bodies (452-458).

With reference to FIG. 4A, an example of a device for spine adjustment is depicted, according to some embodiments. In some embodiments, the device for spine adjustment comprises a template structure (470). In some embodiments, the template structure (470) may comprise wood, plastic or polymer, cork, metal, or any combination thereof. In some embodiments, the template structure (470) is physically coupled to the stationary solid frame (430). In some embodiments, the template structure (470) is separate from the solid frame (430) and un-bound from the solid frame (430).

In some embodiments, the template structure (470) is movable. FIG. 4A depicts a non-limiting example of a template structure (470) that is movable in a horizontal direction (e.g., depicted with an arrow pointing in the right direction) with respect to the solid frame (430). In some embodiments, the template structure (470) is movable in any direction in a horizontal plane with respect to the solid frame (430). In some embodiments, the template structure is configured to be inserted in a space between the plurality of wheels of the solid frame and each wheel of the moveable columns of the plurality of moveable columns. In some embodiments, the template structure (470) is configured to slide across the plurality of wheels of the solid frame (430) with respect to the solid frame (430). In some embodiments, the template structure (470) is physically coupled to a gear (not shown), and the gear is physically coupled to a crank (not shown). In some embodiments, the crank is moveable by human touch. In some embodiments, when a user moves the crank in a first direction, the template structure (470) is configured to move in the same first direction. For example, in some embodiments, where a user moves the crank in a forward circular direction, the template structure (470) is configured to move in a corresponding linear direction with respect to the solid frame (430).

In some embodiments, the template structure (470) may comprise a top configuration (e.g., a top portion of the template structure (470)). FIG. 4A depicts a non-limiting example of a top configuration comprising two peaks. In some embodiments, the top configuration may comprise one or more peaks, two or more peaks, three or more peaks, four or more peaks, five or more peaks, six or more peaks, seven or more peaks, eight or more peaks, nine or more peaks, or ten or more peaks. In some embodiments, the top configuration may comprise wood, foam, cork, metal, or any combination thereof. In some embodiments, the top configuration may be configured to contact the wheels (462-468) of the plurality of moveable columns (440). In some embodiments, the top configuration is configured to guide the wheels (462-468) of the plurality of moveable columns (440) across the template structure (470). In some embodiments, when the top configuration slides across the wheels of the solid frame, the shape of the top configuration guides and moves the plurality of moveable columns (440) in a vertical direction to thereby provide a massage to the person on the device. In some embodiments, the top configuration is designed to move and guide the plurality of moveable columns (440) in a way to provide a massage to the person on the device.

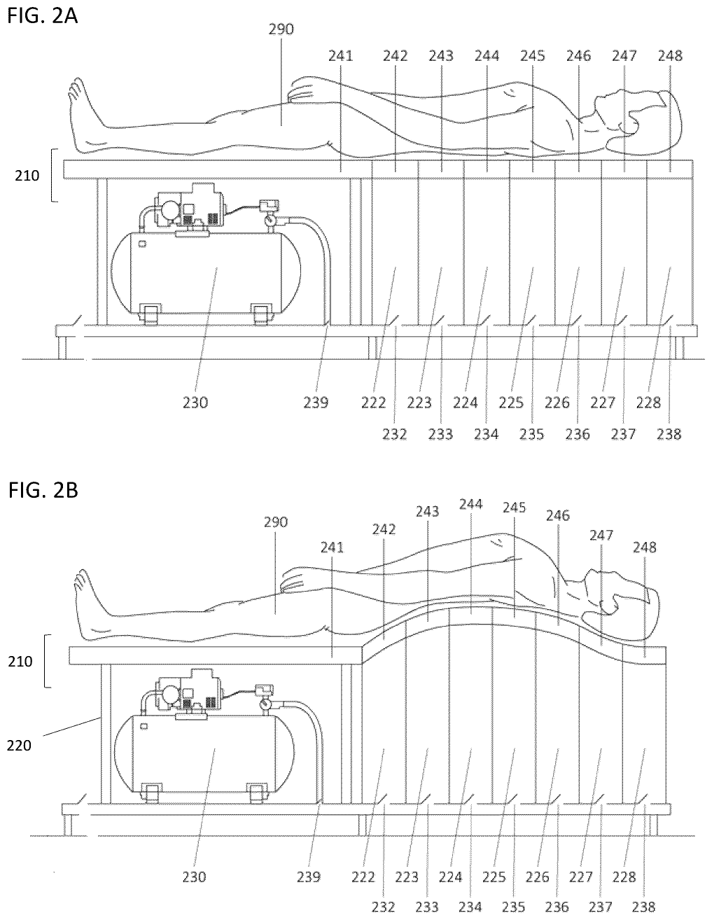

With reference to FIGS. 2A and 2B, an example of a device for spine adjustment (e.g., a “Spine Piano”) is depicted, according to some embodiments. In some embodiments, the device for spine adjustment comprises a support structure (210) configured to hold the weight of a person (290) when the person (290) is on the device. In some embodiments, the support structure (210) comprises one or more inflatable segments (222-228; 242-248). In some embodiments, each of the one or more inflatable segments (222-228; 242-248) may comprise a cushion (242-248) and a chamber (222-228). In some embodiments, each of the one or more inflatable segments (222-228; 242-248) may comprise a cushion. In some embodiments, the cushion (242-248) of the one or more inflatable segments (222-228; 242-248) may comprise silicon, upholstering materials, leather, cork, foam, or any combination thereof. In some embodiments, the chamber (222-228) of the one or more inflatable segments (222-228; 242-248) may comprise rubber, sealed canvas, one or more hermetic materials, or any combination thereof.

In some embodiments, the one or more inflatable segments (222-228; 242-248) are configured to hold the weight of a person (290). In some embodiments, the one or more inflatable segments (222-228; 242-248) may comprise rubber. In some embodiments, the one or more inflatable segments (222-228; 242-248) may comprise sealed canvas. In some embodiments, the one or more inflatable segments (222-228; 242-248) may comprise other hermetic flexible materials that may be suitable to expand with air and contain air within itself. In some embodiments, the one or more inflatable segments (222-228; 242-248) are configured to rise and fall with air. For example, as depicted in FIG. 2A, the inflatable segments (222-228; 242-248) may not be filled with air (e.g., in a starting position) at one time, and, as depicted in FIG. 2B, the inflatable segments (222-228; 242-248) may be filled with air at another time (e.g., in a working position). In some embodiments, the one or more inflatable segments (222-228; 242-248) are configured to rise and fall with air in a sequence in order to provide a massage to the person (290). In some embodiments, the inflatable segments (222-228; 242-248) are controlled individually and simultaneously by a user to either remain in place or to move vertically up and down (rise and fall) to any chosen height within a specific range of motion. This may be done while the person (290) is lying on the device, thus providing stretches and massages to the body of the person (290).

FIGS. 2A and 2B depict non-limiting examples of a support structure (210) comprising seven inflatable segments (222-228; 242-248). In some embodiments, the one or more inflatable segments (222-228; 242-248) of the support structure (210) may comprises two or more, three or more, four or more, five or more, six or more, seven or more, eight or more, nine or more, ten or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, or 30 or more, 31 or more, 32 or more, 33 or more, 34 or more, 35 or more, 36 or more, 37 or more, 38 or more, 39 or more, 40 or more, 41 or more, 42 or more, 43 or more, 44 or more, 45 or more, 46 or more, 47 or more, 48 or more, 49 or more, or 50 or more inflatable segments (222-228; 242-248). In some embodiments, the one or more inflatable segments (222-228; 242-248) of the support structure (210) may comprise 50 or less, 49 or less, 48 or less, 47 or less, 46 or less, 45 or less, 44 or less, 43 or less, 42 or less, 41 or less, 40 or less, 39 or less, 38 or less, 37 or less, 36 or less, 35 or less, 34 or less, 33 or less, 32 or less, 31 or less, 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, 3 or less, 2 or less, or 1 or less inflatable segments (222-228; 242-248).

In some embodiments, each cushion (242-248) of each inflatable segment of the one or more inflatable segments (222-228; 242-248) may comprise a length of 1 or more inches. In some embodiments, each cushion (242-248) of each inflatable segment in the one or more inflatable segments (222-228; 242-248) may comprise a length of 2 or more inches, 4 or more inches, 6 or more inches, 8 or more inches, 10 or more inches, 12 or more inches, 14 or more inches, 16 or more inches, 18 or more inches, 20 or more inches, 22 or more inches, 24 or more inches, 26 or more inches, 28 or more inches, 30 or more inches, 32 or more inches, 34 or more inches, 36 or more inches, 38 or more inches, 40 or more inches, 42 or more inches, 44 or more inches, 46 or more inches, 48 or more inches, 50 or more inches, 52 or more inches, 54 or more inches, 56 or more inches, 58 or more inches, 60 or more inches, 62 or more inches, 64 or more inches, 66 or more inches, 68 or more inches, or 70 or more inches. In some embodiments, each cushion (242-248) of each inflatable segment in the one or more inflatable segments (222-228; 242-248) may comprise a length of 70 or less inches, 68 or less inches, 66 or less inches, 64 or less inches, 62 or less inches, 60 or less inches, 58 or less inches, 56 or less inches, 54 or less inches, 52 or less inches, 50 or less inches, 48 or less inches, 46 or less inches, 44 or less inches, 42 or less inches, 40 or less inches, 38 or less inches, 36 or less inches, 34 or less inches, 32 or less inches, 30 or less inches, 28 or less inches, 26 or less inches, 24 or less inches, 22 or less inches, 20 or less inches, 18 or less inches, 16 or less inches, 14 or less inches, 12 or less inches, 10 or less inches, 8 or less inches, 6 or less inches, 4 or less inches, or 2 or less inches.

In some embodiments, all of the cushions (242-248) of the inflatable segments of the one or more inflatable segments (222-228; 242-248) are of equal size and dimension. In some embodiments, each cushion (242-248) of the inflatable segment in the one or more inflatable segments (222-228; 242-248) are of different size and dimension. In some embodiments, some of the cushions (242-248) of the inflatable segments in the one or more inflatable segments (222-228; 242-248) are of equal size and dimension as other cushions (242-248) in the one or more inflatable segments (222-228; 242-248), and some of the cushions (242-248) in the one or more inflatable segments (222-228; 242-248) are of different size and dimension as other cushions (242-248) in the one or more inflatable segments (222-228; 242-248).

In some embodiments, all of the inflatable segments in the one or more inflatable segments (222-228; 242-248) are of equal size and dimension. In some embodiments, each inflatable segment in the one or more inflatable segments (222-228; 242-248) are of different size and dimension. In some embodiments, some of the inflatable segments in the one or more inflatable segments (222-228; 242-248) are of equal size and dimension as other inflatable segments in the one or more inflatable segments (222-228; 242-248), and some of the inflatable segments in the one or more inflatable segments (222-228; 242-248) are of different size and dimension as other inflatable segments in the one or more inflatable segments (222-228; 242-248).

With reference to FIGS. 2A and 2B, in some embodiments, the device for spine adjustment as described herein may comprise an air compressor (230). In some embodiments, the air compressor (230) may be configured to generate air pressure. In some embodiments, the air compressor (230) provides air to the one or more inflatable segments (222-228; 242-248) of the device. In some embodiments, the air compressor (230) as described herein may comprise any existing air compressor. In some embodiments, the air compressor (230) may comprise one or more of a compressor, an air cooler, an air receiver tank, a filter, a dryer, a condensate trap, and a distribution system, or any combination thereof. In some embodiments, the air compressor (230) may be connected to a power source through a wire. In some embodiments, the air compressor (230) may be positioned next to the support structure (210) and a stationary solid frame (220). In some embodiments, the air compressor (230) may be positioned atop the solid frame (220) and below the support structure (210).

In some embodiments, the air compressor (230) generates air and moves the air through an air compressor tube (239). In some embodiments, the air compressor tube (239) may be configured to provide a pathway for air from the air compressor (230) to the one or more inflatable segments (222-228; 242-248). In some embodiments, the air compressor tube (239) allows air from the air compressor (230) to travel to one or more valves (232-238). In some embodiments, the one or more valves (232-238) are physically coupled to one or more chambers (222-228) of the one or more inflatable segments (222-228; 242-248). In some embodiments, the one or more chambers (222-228) are physically coupled to the cushions (242-248) of the one or more inflatable segments (222-228; 242-248)., thus forming the one or more inflatable segments (222-228; 242-248). Accordingly, in some embodiments, air generated by the air compressor (230) may travel from the air compressor tube (239) into the one or more valves (232-238) and into the one or more inflatable segments (222-228; 242-248) (e.g., the chambers and the cushions).

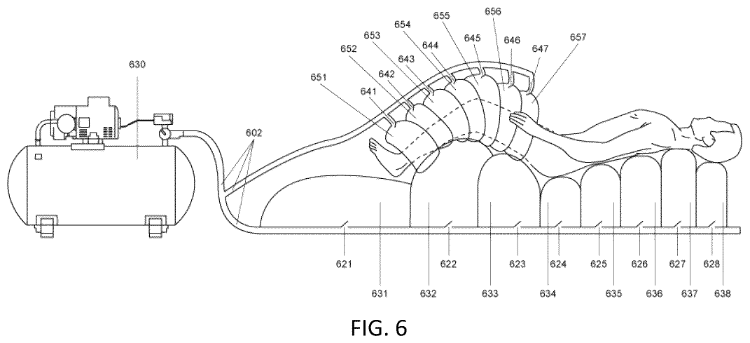

In some embodiments, and with reference to FIG. 6, the one or more inflatable segments (631-638; 651-657) may comprise one or more chambers (631-638; 651-657). For example, in FIG. 6, the one or more inflatable segments (631-638; 651-657) is the one or more chambers (631-638; 651-657). In some embodiments, the one or more inflatable segments (631-638; 651-657) may not comprise a cushion, as shown in FIGS. 2A and 2B. In some embodiments, the one or more inflatable segments (631-638; 651-657) (e.g., see 651-657 in FIG. 6) may be configured to wrap around a portion of a person (290). For example, in some embodiments, the one or more inflatable segments (631-638; 651-657) may be configured to wrap around the feet, legs, hips, gluteus maximus region, hips, lower back, upper back, neck, head, or any combination thereof of the person (290). FIG. 6 shows a non-limiting example of inflatable segments (631-638; 651-657) (e.g., see 651-657 in FIG. 6) configured to wrap around the legs of a person (290). In some embodiments, the one or more inflatable segments (631-638; 651-657) wrapped around the person (290) may grow by filling up with air from the air compressor (630). In some embodiments, the one or more inflatable segments (631-638; 651-657) wrapped around the person (290) may shrink by releasing air from the one or more inflatable segments (631-638; 651-657). In some embodiments, the growth and shrinkage of the one or more inflatable segments (631-638; 651-657) with air may provide a massage to the person.

In some embodiments, when the one or more inflatable segments (631-638; 651-657) are filled with air from the air compressor (630), the one or more inflatable segments (631-638; 651-657) may provide compression to the portion of the person's body that the one or more inflatable segments (631-638; 651-657) are wrapped around. In some embodiments, the compression may increase or decrease blood flow to the portion of the person's body that the one or more inflatable segments (631-638; 651-657) are wrapped around. In some embodiments, the compression may provide a massage to the person. In some embodiments, the one or more inflatable segments (631-638; 651-657) may be configured to rise and fall with air in order to provide a massage and/or a stretch to the portion of the person's body that the one or more inflatable segments (631-638; 651-657) are wrapped around (e.g., the person's legs).

### Example Silk Wraps

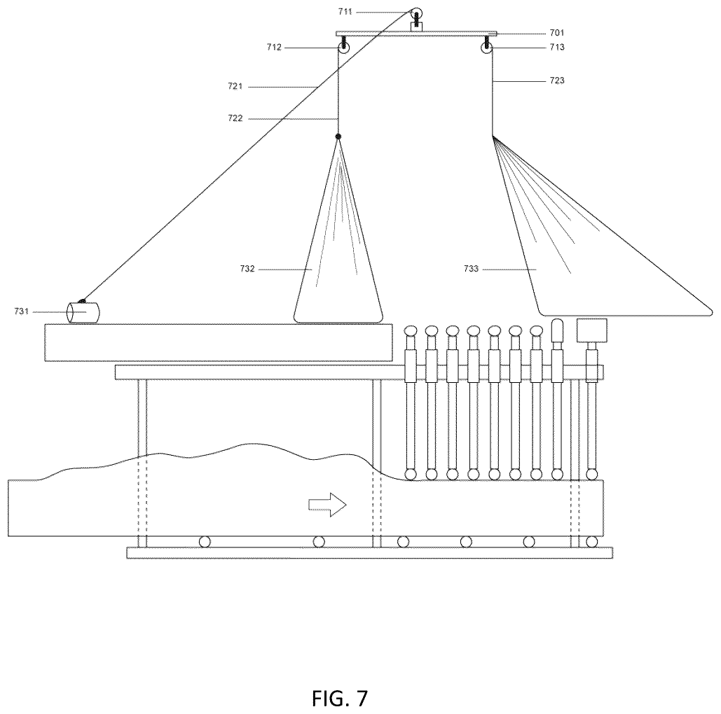

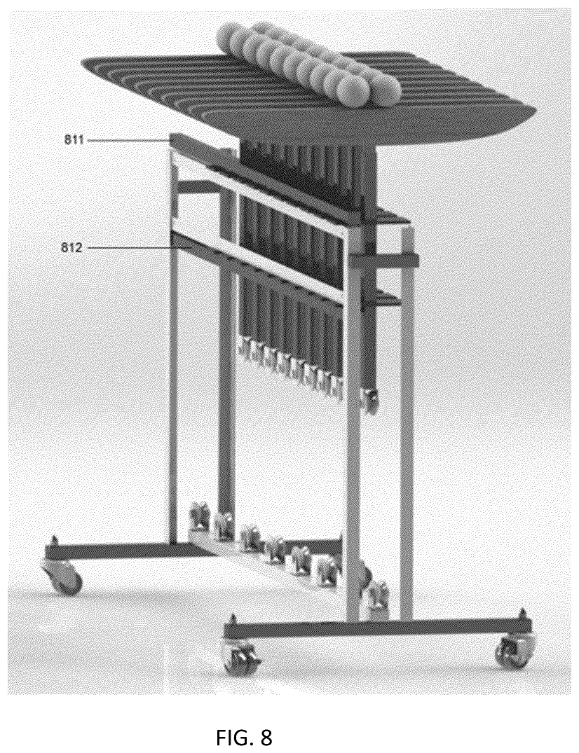

With references to FIG. 7, in some embodiments, the device for spine adjustment as described herein may comprise one or more silk wraps (731-733). In some embodiments, the one or more silk wraps (731-733) may comprise nylon, polyester, spandex, cotton, silk, linen, kevlar (e.g., aramid fiber), or any other material suitable for silk wraps (731-733). In some embodiments, the one or more silk wraps (731-733) may comprise a cuff, for example 731 in FIG. 7. In some embodiments, the cuff may comprise an attachment to wrap around and hold a portion of a person (190).

In some embodiments, the one or more silk wraps (731-733) may be bound to a ceiling to provide support for the one or more silk wraps (731-733). In some embodiments, and with reference to FIG. 7, the one or more silk wraps (731-733) may be bound to one or more cables (721-723). In some embodiments, the one or more cables (721-723) provide support to the one or more silk wraps (731-733). In some embodiments, the one or more cables (721-723) may be bound to one or more pulleys and/or cranks (711-713). In some embodiments, the one or more pulleys and/or cranks (711-713) may provide support to the one or more cables (721-723) and the one or more silk wraps (731-733). In some embodiments, the one or more pulleys and/or cranks (711-713) may be bound to a support beam (701). In some embodiments, the support beam (701) may be attached to a column (not shown) attached to the solid frame. In some embodiments, the support beam (701) may be bound to the ceiling. In some embodiments, the support beam (701) may be free-standing. In some embodiments, the one or more silk wraps (731-733) may be connected to the ceiling with one or more of carabiner clips, a figure 8 descender, a swivel, a bolt, one or more screws, or any combination thereof. In some embodiments, the one or more pulleys and/or cranks (711-713) are physically coupled to a support beam (701) coupled to and positioned above the solid frame. In some embodiments, the support beam (701) comprises one or more moveable tracks, wherein the one or more pulleys and/or cranks (711-713) are position on the one or more moveable tracks and the one or more pulleys and/or cranks (711-713) are configured to slide across the one or more moveable tracks. In some embodiments, the one or more silk wraps (731-733) are configured to support, lift, and/or stretch a portion of the person (190).

In some embodiments, the one or more silk wraps (731-733) are configured to move in a horizontal plane with respect to the device for spine adjustment. In some embodiments, the one or more silk wraps (731-733) are configured to move in a vertical plane with respect to the device for spine adjustment. In some embodiments, the one or more silk wraps (731-733) are configured to move in a horizontal plane and in a vertical plane with respect to the device for spine adjustment. In some embodiments, the one or more silk wraps (731-733) are configured to move in horizontal plane, a vertical plane, a diagonal plane, or any combination thereof with respect to the device for spine adjustment. In some embodiments, the one or more silk wraps (731-733) may be positioned in a hanging position atop the device for spine adjustment. In some embodiments, the one or more silk wraps (731-733) may be positioned in a hanging position to the side of the device for spine adjustment. In some embodiments, the one or more silk wraps (731-733) may be positioned in a hanging position to below the device for spine adjustment.

In some embodiments, the one or more silks (731-733) may be positioned at a first portion of the support structure. In some embodiments, the one or more silks (731-733) positioned at the first portion of the support structure may be configured to hold and move a portion of the body of a person (190) (e.g., arms, shoulder, neck, head) to enhance stretching and movement of the body of a person (190) and reduce muscle tension.

In some embodiments, the one or more silks (731-733) may be positioned at a second portion of the support structure. In some embodiments, the one or more silks (731-733) positioned at the second portion of the support structure may be configured to hold and move a portion of the body of a person (190) (e.g., feet, legs, hips, gluteus maximus area) to enhance stretching and movement of the body of a person (190) and reduce muscle tension.

In some embodiments, the one or more silks (731-733) may be positioned at a third portion of the support structure. In some embodiments, the one or more silks (731-733) positioned at the third portion of the support structure may be configured to hold and move a portion of the body of a person (190) (e.g., feet, legs, hips, gluteus maximus) to enhance stretching and movement of the body of a person (190) and reduce muscle tension.

### Definitions

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used herein, the term “similar” means two shapes having corresponding sides proportional and corresponding angles equal. Moreover, if minor changes are made to one or both shapes, they are considered substantially similar to each other. For example, a larger triangle with three equal sides is similar to a smaller triangle with three equal sides. If the smaller triangle has one or more corners beveled, it is substantially similar to the larger triangle.

The section headings used herein are for organizational purposes only and are not to be construed as limiting the subject matter described.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A device for spine adjustment, comprising:
(a) a support structure configured to support a person, comprising:
(i) a first portion configured to support a top portion of the person, wherein the first portion comprises a plurality of movable columns; and
(ii) a second portion configured to support a bottom portion of the person; and
(b) a solid frame configured to provide structure to the device, wherein the solid frame is physically coupled to the support structure.

2. The device of claim 1, wherein each movable column in the plurality of movable columns comprises:
(a) a cushion configured to contact the person;
(b) a vertical body physically coupled to the cushion;
(c) a track physically coupled to the solid frame; and
(d) a wheel physically coupled to the vertical body.

3. (canceled)

4. The device of claim 2, wherein the cushion comprises one or more shapes.

5-7. (canceled)

8. The device of claim 2, wherein the vertical body is physically coupled to the track.

9-10. (canceled)

11. The device of claim 2, wherein the solid frame comprises a plurality of wheels.

12. The device of claim 11, further comprising a template structure comprising a top configuration designed to contact the wheel of each of the movable columns, wherein the template structure is configured to be inserted in a space between the plurality of wheels of the solid frame and each wheel of the moveable columns.

13. (canceled)

14. The device of claim 12, wherein the template structure is configured to slide across the plurality of wheels of the solid frame with respect to the solid frame, and wherein the top configuration of the template structure is designed to move the movable columns vertically with respect to the solid frame when the template structure is moved.

15. The device of claim 14, further comprising a gear and a crank physically coupled to the template structure, wherein the gear and the crank are configured to move the template structure with respect to the solid frame.

16.-24. (canceled)

25. The device of claim 2, wherein the track comprises a first sliding plate and a second sliding plate for each moveable column in the plurality of moveable columns.

26. (canceled)

27. The device of claim 25, wherein the first sliding plate and the second sliding plate are disposed atop the other.

28. The device of claim 25, wherein the first sliding plate and the second sliding plate are held against the solid frame via horizontal bars.

29. The device of claim 28, wherein the horizontal bars are configured to hold the first sliding plate and the second sliding plate with one or more clamps.

30. The device of claim 29, wherein the one or more clamps are configured to add or reduce tension exerted on the on the first sliding plate and/or the second sliding plate by holding the horizontal bars to the solid frame.

31. The device of claim 25, wherein the first sliding plate and the second sliding plate comprise holes comprising a width that is larger than a width of the vertical body.

32. The device of claim 31, wherein the vertical body slides through the holes of the first sliding plate and the second sliding plate.

33. The device of claim 28, wherein when the horizontal bars are released from the solid frame, the first sliding plate and the second sliding plate are movable in a horizontal plane, thereby changing the position and/or angle of one of the plurality of moveable columns.

34. A device for spine adjustment comprising:
(a) a support structure configured to support a person, comprising:
(i) a first portion configured to support a top portion of the person, wherein the first portion comprises a plurality of movable columns; and
(ii) a second portion configured to support a bottom portion of the person; and
(b) a solid frame physically coupled to the support structure; and
(c) a plurality of actuators, wherein each actuator in the plurality of actuators is physically coupled to each movable column of the plurality of movable columns.

35. The device of claim 34, wherein each movable column in the plurality of movable columns comprises:
(a) a cushion configured to contact the person;
(b) a vertical body physically coupled to the cushion; and
(c) a track physically coupled to the solid frame.

36.-62. (canceled)

63. A device for spine adjustment, comprising:
(a) a support structure configured to support a person, comprising one or more inflatable segments, wherein the one or more inflatable segments comprises one or more cushions and one or more chambers;
(b) one or more valves connected to one or more chambers, wherein each of the one or more chambers is physically coupled to the one or more cushions;
(c) an air compressor configured to provide air to the one or more inflatable segments; and
(d) a solid frame physically coupled to the support structure.

64.-73. (canceled)
